(19) United States
(12) Patent Application Publication
(10) Pub. No.: US 2010/0150435 A1
(43) Pub. Date: Jun. 17, 2010

(54) IMAGE PROCESSING METHOD AND APPARATUS, AND DIGITAL PHOTOGRAPHING APPARATUS USING THE IMAGE PROCESSING APPARATUS

(75) Inventor: Hyun-ock Yim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/633,873

(22) Filed: Dec. 9, 2009

(30) Foreign Application Priority Data
Dec. 16, 2008 (KR) 10-2008-0128194

(51) Int. Cl. G06K 9/00; G06K 9/48

(52) U.S. Cl. 382/162; 382/199

(57) ABSTRACT

Provided is an image processing method and apparatus. The image processing method includes: detecting a face area from an input image; and performing a color process according to the detected face area. Accordingly, expressing of a skin color is not restricted since a color to be processed with a different color and a color area overlap.

### CROSS-REFERENCE TO RELATED PATENT APPLICATION

This application claims the benefit of Korean Patent Application No. 10-2008-0128194, filed on Dec. 16, 2008, in the Korean Intellectual Property Office, the disclosure of which is incorporated herein in its entirety by reference.

### BACKGROUND

The present invention relates to processing an image and more particularly, to an image processing method and apparatus which performs color reproduction according to face detection of an image, and a digital photographing apparatus using the image processing apparatus.

Color reproduction denotes reproducing a color of an original subject or a picture in a color picture, a color television, a color video system, a color printing, etc.

A digital image processing apparatus, such as a digital photographing apparatus, uses a color reproduction technology in order to reproduce the original impression of a color of a subject or to express the subject in a desired color. Since features of data received from an image sensor differ according to color temperature, conventional color reproduction technologies classify and process color reproduction according to the flash or the color temperature.

However, such conventional color reproduction technologies are performed only according to color temperature, and therefore make it difficult to incorporate a portion desired by a user, for example, a skin color of the most important person in a character picture. An actual skin color is between red and yellow. Accordingly, it is difficult to reproduce red, yellow, and skin color as desired regardless of a flash or color temperature. For example, when colors in a red range are changed in order to express a red apple in a more red manner, a skin color also changes. Alternatively, when color reproduction matrix, hue control, or saturation control is performed in order to express a yellow flower in more vivid color, a skin color also changes. Accordingly, either the vividness of the yellow flower or the proper skin color needs to be disregarded.

### SUMMARY

The present invention provides an image processing method and apparatus for processing a color according to detection of a face instead of color temperature.

The present invention also provides a digital photographing apparatus using the image processing apparatus.

According to an aspect of the present invention, there is provided an image processing method including: detecting a face area from an input image; and performing a color process according to the detected face area.

The color process may be a first color process performed on the detected face area, when the face area is detected from the input image.

The processing of the color may be a second color process performed on the input image, when the face area is not detected from the input image.

The image processing method may further include extracting face information about the detected face area, wherein in the performing of the color process, the first color process is performed on the face area based on the extracted face information.

When at least two face areas are detected from the input image, the extracting of the face information may extract face information about each of the at least two face areas, and the performing of the color process may perform different first color processes according to each piece of face information about the at least two face areas.

The color process may include at least one of a color reproduction matrix process, a hue process, and a saturation process.

According to another aspect of the present invention, there is provided an image processing method including: performing a first color process on an input image; detecting a face area from the input image on which the first color process is performed; and performing a second color process based on whether the face area is detected.

The performing of the second color process may be performed on the detected face area, when the face area is detected from the input image.

The image processing method may further include extracting face information about the detected face area, wherein the performing of the second color process is performed on the face area based on the extracted face information.

When at least two face areas are detected from the input image on which the first color process is performed, the extracting of the face information may extract face information about each of the detected at least two face areas, and the performing of the second color process may perform different second color processes on the each of the detected at least two face areas according to each piece of face information.

The first and second color processes may include at least one of a color reproduction matrix process, a hue control process, and a saturation control process.

According to another aspect of the present invention, there is provided an image processing apparatus including: a face area detector which detects a face area from an input image; and a color processor which performs a color process based on whether the face area is detected.

The image processing apparatus may further include a controller which performs a first color process on the detected face area when the face area is detected from the input image, and performs a second color process on the input image when the face area is not detected from the input image.

The image processing apparatus may further include a face information extractor which extracts face information about the detected face area, wherein the color processor performs the first color process on the face area based on the extracted face information.

When at least two face areas are detected from the input image, the controller may extract face information about each of the detected at least two face areas, and perform different first color processes on the each of the detected at least two face areas according to each piece of face information.

The color processor may include: a color reproduction matrix which converts an RGB value of the input image; a hue controller which emphasizes a hue component of the input image; and a saturation controller which emphasizes a saturation component of the input image.

According to another aspect of the present invention, there is provided a digital photographing apparatus including the above image processing apparatus.

The input image may include a static image or a moving image.

The input image may include a live view image or a captured image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram schematically illustrating a digital photographing apparatus according to an embodiment of the present invention;

FIG. 2 is a block diagram schematically illustrating a digital signal processor of FIG. 1;

FIG. 3 is a block diagram schematically illustrating a color processor of FIG. 2;

FIG. 4 is a flowchart illustrating an image processing method according to an embodiment of the present invention;

FIG. 5 is a flowchart illustrating an image processing method according to another embodiment of the present invention; and

FIG. 6 is a flowchart illustrating an image processing method according to another embodiment of the present invention.

### DETAILED DESCRIPTION OF THE EMBODIMENTS

Hereinafter, the present invention will be described more fully with reference to the accompanying drawings, in which exemplary embodiments of the invention are shown. Also, while describing the present invention, detailed descriptions about related well-known functions or configurations that may diminish the clarity of the points of the present invention are omitted.

Unless defined otherwise, technical and scientific terms used herein have the same meaning as is commonly understood by one of ordinary skill in the art to which this invention belongs.

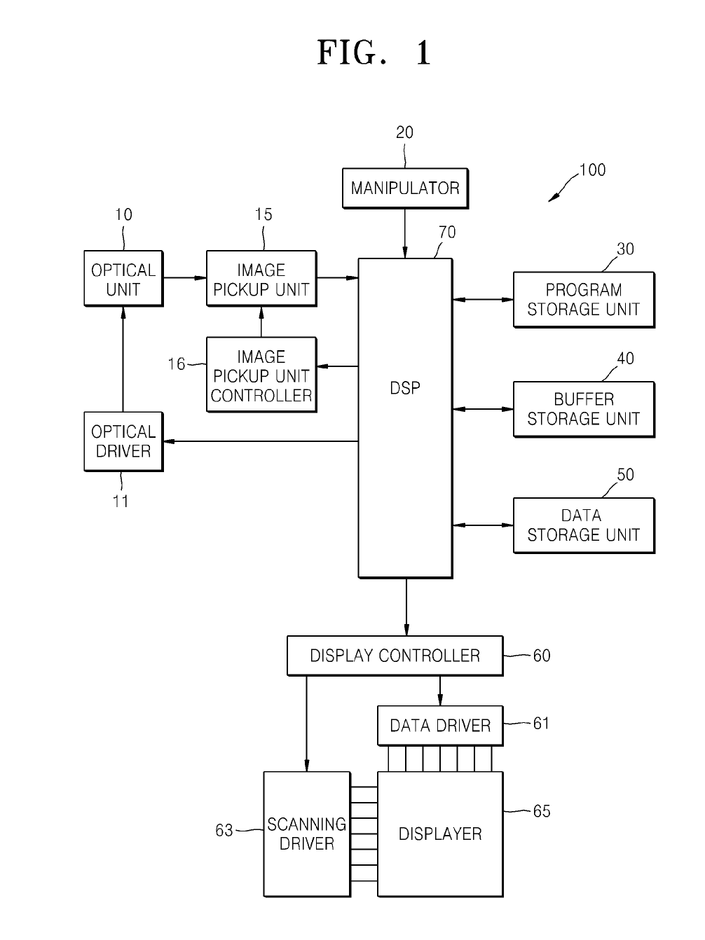

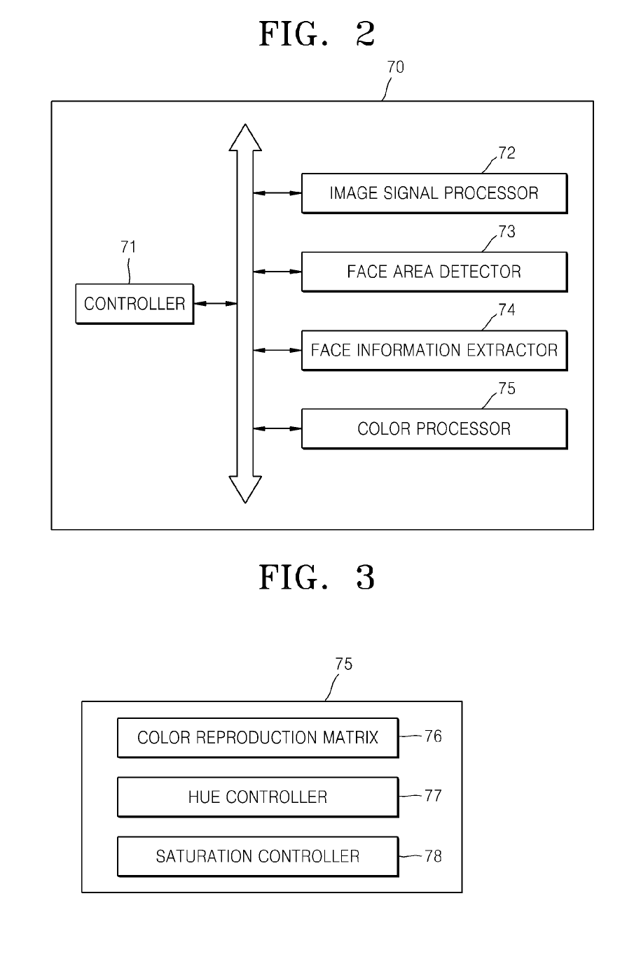

FIG. 1 is a block diagram schematically illustrating a digital photographing apparatus 100 according to an embodiment of the present invention, and FIG. 2 is a block diagram schematically illustrating a digital signal processor (DSP) 70 of FIG. 1.

Referring to FIG. 1, the digital photographing apparatus 100 includes an optical unit 10, an optical driver 11, an image pickup unit 15, an image pickup unit controller 16, a manipulator 20, a program storage unit 30, a buffer storage unit 40, a data storage unit 50, a display controller 60, a data driver 61, a scanning driver 63, a displayer 65, and the DSP 70.

The optical unit 10 receives an optical signal from a subject, and transmits the received optical signal to the image pickup unit 15. The optical unit 10 may include at least one lens such as a zoom lens, which narrows or widens a view angle according to a focal length, and a focus lens, which adjusts a focus of the subject. The optical unit 10 may further include an iris which adjusts light intensity.

The optical driver 11 adjusts a location of a lens and closes or opens an iris. The focus may be adjusted by moving a location of a lens. Also, the light intensity may be adjusted by opening or closing an iris. The optical driver 11 may control the optical unit 10 according to a control signal, which is automatically generated by an image signal received in real time or is manually input by manipulation of a user.

An optical signal that passed through the optical unit 10 forms an image of the subject on a light receiving surface of the image pickup unit 15. The image pickup unit 15 may use a charge coupled device (CCD) or a complementary metal oxide semiconductor image sensor (CIS), which convert an optical signal to an electric signal. Sensitivity or the like of the image pickup unit 15 may be adjusted by the image pickup unit controller 16. The image pickup unit controller 16 may control the image pickup unit 15 according to a control signal, which is automatically generated according to an image signal received in real time or is manually input by manipulation of the user.

The manipulator 20 may be used to receive a control signal from the outside, such as the user. The manipulator 20 includes a shutter-release button, which receives a shutter-release signal for capturing an image by exposing the image pickup unit to light for a predetermined time, a power supply button, which is pressed to supply power to the digital photographing apparatus 100, a wide angle-zoom button and a telescopic-zoom button, which widens or narrows a view angle according to an input, and various function buttons for selecting a mode, such as a character input mode, a photographing mode, or a reproducing mode, for selecting a white balance setting function, and for selecting an exposure setting function. As described above, the manipulator 20 may have a form including various buttons, but is not limited thereto. The manipulator 20 may have a form that receives an input of the user, such as a keyboard, a touch pad, a touch screen, or a remote controller.

The digital photographing apparatus 100 includes the program storage unit 30, which stores programs such as an operating system and an application system for operating the digital photographing apparatus 100, the buffer storage unit 40, which temporarily stores data required to operate the digital photographing apparatus 100 or result data, and the data storage unit 50, which stores various pieces of information required for a program and an image file including an image signal.

Moreover, the digital photographing apparatus 100 includes the display controller 60, which displays an operating status or information about an image captured by the digital photographing apparatus 100, the data driver 61 and the scanning driver 63, which transmit display data received from the display controller 60 to the displayer 65, and the displayer 65, which displays a predetermined image according to a signal received from the data driver 61 and the scanning driver 63. The displayer 65 may be a liquid crystal display panel (LCD), an organic light emitting display panel (OLED), or an electrophoresis display panel (EPD).

Also, the digital photographing apparatus 100 includes the DSP 70, which processes a received image signal and controls each element according to the image signal or an external input signal.

The DSP 70 will now be described with reference to FIG. 2.

Referring to FIG. 2, the DSP 70 includes a controller 71, an image signal processor 72, a face area detector 73, a face information extractor 74, and a color processor 75. The term “DSP” can be interpreted as having the same meaning as “an image processing apparatus”.

The controller 71 controls overall operations of the DSP 70.

The image signal processor 72 converts an image signal received from the image pickup unit 15 to a digital signal, and processes the image signal, such as gamma correction, color filter array interpolation, color matrix, color correction, color enhancement, or the like, so that the image signal is suitable for the viewpoint of a person. Here, functions related to color processes according to color reproduction according to an embodiment of the present invention are performed in the color processor 75, instead of the image signal processor 72.

When the image signal processor 72 is to process the image signal, an auto white balance or auto exposure algorithm may be performed. Also, the size of image data is adjusted by using a scaler, and an image file having a predetermined form by compressing the image data is formed. Alternatively, an image file may be decompressed. The image signal processor 72 may process image signals that are received via an image signal and a shutter release signal received in real time in a live-view mode before taking a photograph. Here, the image signals may be differently processed.

The face area detector 73 detects a face area from an image processed through the image signal processor 72. In other words, the face area detector 73 detects where a face is in an input image. The face area detector 73 determines whether the input image includes feature data of a face by comparing pre-stored feature data of a face and data of the input image, and when the input image includes the feature data, recognizes a location of the face in the input image. Many conventional technologies exist for detecting a face area, and a face area may be detected via Adaboosting algorithm or skin color information. Here, a face area may not exist in the input image, or one or at least two face areas may exist in the input image.

The face information extractor 74 extracts face information about the detected face area. Here, the face information includes a face size, a face location, and a face skin color or a face. In other words, the number of pixels in the face, a location of the pixels of the face in the entire image, and color information of the face area are extracted based on the detected face area. Also, when a plurality of face areas exist in the input image, face information is extracted from each of the face areas.

The color processor 75 performs different color processes based on whether the face area is detected. In other words, when the face area is detected in the input image, different color processes are performed on the detected face area and remaining areas. For example, a parameter of a color reproduction matrix of the face area and a parameter of a color reproduction matrix of the remaining areas are differentiated, so that color reproductions of the face area and the remaining areas do not collide with each other. Also, the color processor 71 may control the color processor 75 to perform different color processes on a plurality of face areas.

Alternatively, the color processor 75 may perform a different color process on the detected face area after performing an overall color process on the input image.

When the face area is detected by the face area detector 73, the controller 71 controls the color processor 75 to perform a first color process on the detected face area. However, when the face area is not detected, the color processor 75 is controlled to perform a second color process on the input image. Here, the first and second color processes include color processing methods such as color reproduction matrix, hue control, and saturation control, and mean that different parameters for processing a color are set for the face area and the remaining areas other than the face area.

When the face area detector 73 detects a plurality of face areas in the input image, the controller 71 controls the face information extractor 74 to extract face information from each of the face areas. Also, the color processor 75 performs different color processes on each face area based on the extracted face information.

FIG. 3 is a block diagram schematically illustrating the color processor 75 of FIG. 2. The color processor 75 includes a color reproduction matrix 76 which converts an RGB value of the input image, a hue controller 77 which emphasizes a hue component of the input image, and a saturation controller 78 which emphasizes a saturation component of the input image. A color reproduction process according to an embodiment of the present invention includes color reproduction matrix, hue emphasis, and saturation emphasis, but is not limited thereto, and may include other well known color reproduction processes. The color reproduction processes may be independently performed or performed together when required.

According to an embodiment, a color may be processed by converting an RGB signal output from an image sensor to a Hue-Saturation-Intensity (HSI) signal. Here, an HSI color model is expressed in a conical coordinate system. A color is expressed in an angle having a range from 0° to 360° along a circumference of a cone. 0° is red, 120° is green, and 240° is blue. Saturation has a value between 0 and 1, and is expressed in a horizontal distance from a center of the cone. A saturation value at the center of the cone is 0, and thus, a color having the saturation value of 0 is 100% white, and a saturation value at the edge of the cone is 1, and thus, a color having the saturation value of 1 is a primary color without white. Brightness corresponds to a vertical axis, and the lowest brightness is 0 and denotes black, whereas the highest brightness is 1 and denotes white.

The color reproduction matrix 76 adjusts a parameter to be close to an original image by applying a color conversion matrix on R, G, and B output from the image sensor. For example, a red apple may be reproduced in a redder color. Also, colors may be converted from RGB to YCC.

The hue controller 77 emphasizes a hue component of the input image. Here, the hue component means an original color of its corresponding color. For example, when hue is controlled in the face area, red may be increased when a value of the hue component is decreased, and yellow may be increased when the value of the hue component is increased.

The saturation controller 78 emphasizes a saturation component of the input image. Here, saturation denotes purity of a color, and expresses the amount of white mixed to an original color. For example, when a saturation value is decreased, a color is lightened or faded and thus not clear, and when the saturation value is increased, a color is darkened, deepended, or intensified, and thus clearer.

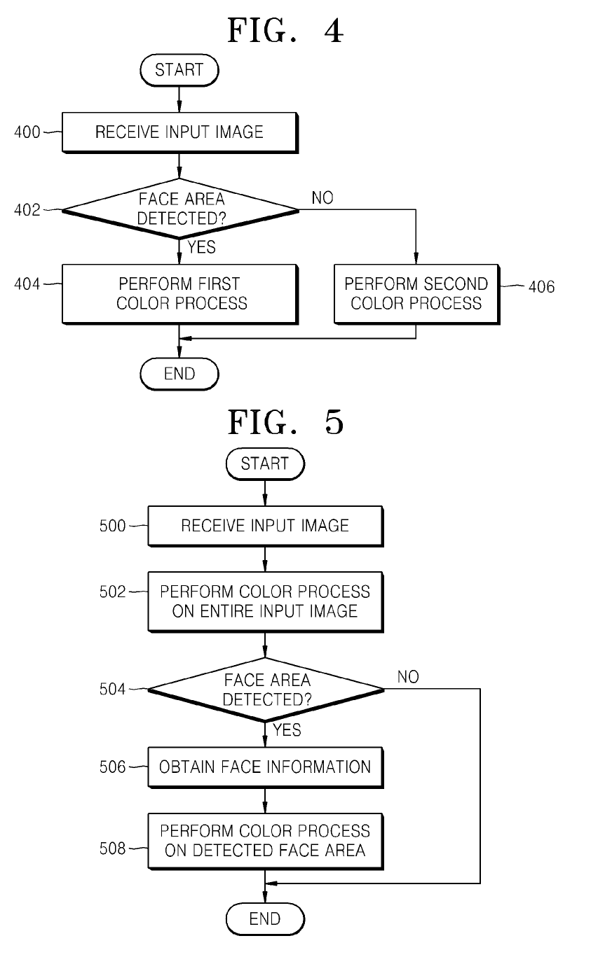

FIG. 4 is a flowchart illustrating an image processing method according to an embodiment of the present invention.

Referring to FIG. 4, an input image is received in operation 400. Here, the input image may be a live view image or a captured image in a digital photographing apparatus. Alternatively, the input image may be a static image or a moving image. Alternatively, the input image may be an image on which a predetermined image process is performed by the image signal processor 72 of FIG. 2. In operation 402, a predetermined face area is detected from the input image. Here, the detecting of the face area may be performed via a well known face detection algorithm. When the face area is detected in operation 402, a first color process is performed on the detected face area in operation 404. Otherwise, when the face area is not detected in operation 402, a second color process is performed on the input image in operation 406. Here, the first and second color processes include color processing methods such as color reproduction matrix, hue control, and saturation control, and may be the same or different processes. However, even when the first and second color processes are the same, they are performed according to different parameters. For example, when the first color process is hue control on the face area and a skin color of a face is to be expressed in a redder color, a value of a hue component is decreased. However, since the second color process is performed when the face area is not detected in the input image, hue components are differently processed according to a subject to be photographed. Accordingly, only the skin color of the face is effectively expressed in red.

FIG. 5 is a flowchart illustrating an image processing method according to another embodiment of the present invention.

Referring to FIG. 5, an input image is received in operation 500. Here, the input image may be a live view image or a captured image in a digital photographing apparatus. Alternatively, the input image may be an image on which a predetermined image process is performed by the image signal processor 72 of FIG. 2.

In operation 502, a color process is performed on the entire input image.

In operation 504, a predetermined face area is detected from the input image. Here, the detecting of the face area may be performed via a well known face detection algorithm. When the face area is detected in operation 504, face information about the detected face area is obtained in operation 506. Here, the face information includes information about a face size, a face location, and a face skin color. In operation 508, a color process is performed on the face area based on the obtained face information. The color process of operation 508 may be identical to or different from the color process of operation 502. However, even when the color processes are the same, i.e., color reproduction matrixes are the same, parameters of the color reproduction matrixes are different. In other words, a color reproduction process may be performed on the entire input image so that the input image is similar to an original image, and then the color reproduction may be performed on the detected face area so that a skin color is similar to the original skin color.

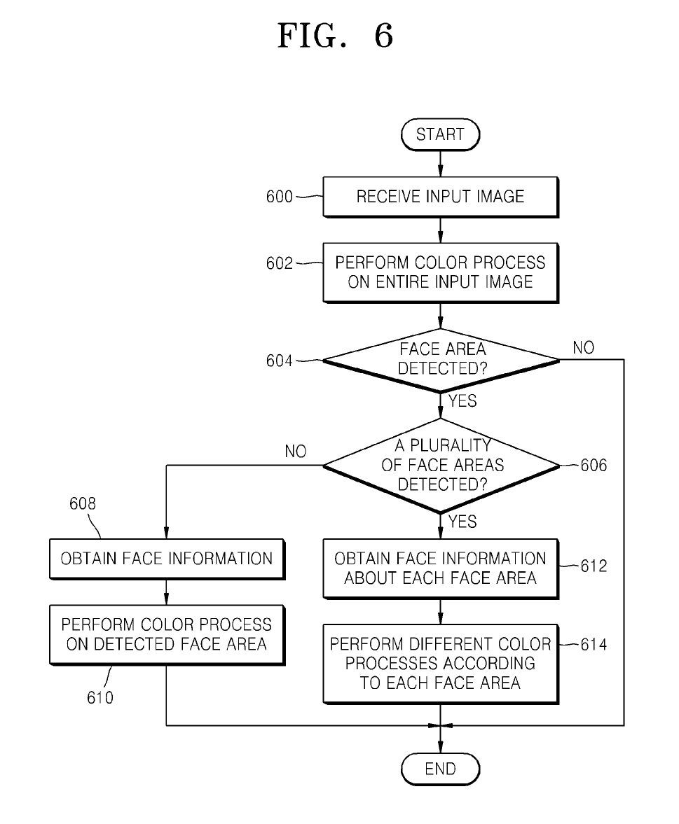

FIG. 6 is a flowchart illustrating an image processing method according to another embodiment of the present invention.

Referring to FIG. 6, an input image is received in operation 600. Here, the input image may be a live view image or a captured image in a digital photographing apparatus. Alternatively, the input image may be an image on which a predetermined image process is performed via the image signal processor 72 of FIG. 2. In operation 602, a color process is performed on the entire input image.

In operation 604, a predetermined face area is detected from the input image. Here, the detecting of the faced area may be performed via a well known face detection algorithm. When the face area is detected in operation 604, it is determined whether a plurality of face areas are detected in operation 606. Here, when it is determined that the plurality of face areas are not detected in operation 606, face information about the face area is obtained in operation 608 and a color process is performed on the face area based on the face information in operation 610.

Otherwise, when it is determined that the plurality of face areas are detected in operation 606, face information about each of the plurality of face areas is obtained in operation 612. In operation 614, color processes are performed on the face areas according to their corresponding face information. Here, the color processes may be identical or different. In other words, the color processes may be a parameter for emphasizing the same color or a parameter for emphasizing different colors according to skin colors of the face areas.

The image processing method according to various embodiments of the present invention include detecting a face area from an input image; and performing a color process according to the detected face area. Accordingly, expressing of a skin color is not restricted since a color to be processed with a different color and a color area overlap.

Specifically, color reproduction processes are performed on an image by dividing the image into areas, such as a person and other subjects, or it is determined whether a person is detected in the image. Accordingly, color reproduction matrix, hue control, and saturation control are differently performed on the person and the other subjects. Consequently, original colors are maintained while improving the expression of a skin color of the person.

In the embodiments described above, a digital camera is mainly discussed as an example of a digital photographing apparatus for applying the present invention, but the digital photographing apparatus is not limited thereto. It will be easily understood by one of ordinary skill in the art that the present invention may be applied to a camera phone, personal digital assistant (PDA), or a portable multimedia player (PMP) having a camera function.

The invention can also be embodied as computer readable codes on a computer readable recording medium. The computer readable recording medium is any data storage device that can store data which can be thereafter read by a computer system, stored in memory, and executed by a processor.

Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. An image processing method comprising:
detecting a face area from an input image with a processor; and
performing a color process with the processor according to the detected face area.

2. The image processing method of claim 1, wherein the color process is a first color process performed on the detected face area, when the face area is detected from the input image.

3. The image processing method of claim 2, wherein the processing of the color is a second color process performed on the input image, when the face area is not detected from the input image.

4. The image processing method of claim 2, further comprising:
extracting face information about the detected face area, wherein in the performing of the color process, the first color process is performed on the face area based on the extracted face information.

5. The image processing method of claim 4, wherein, when at least two face areas are detected from the input image, the extracting of the face information extracts face information about each of the at least two face areas, and the performing of the color process performs different first color processes according to each piece of face information about the at least two face areas.

6. The image processing method of claim 1, wherein the color process comprises at least one of a color reproduction matrix process, a hue process, and a saturation process.

7. An image processing method comprising:
performing a first color process with a processor on an input image;
detecting a face area with the processor from the input image on which the first color process is performed; and
performing a second color process based on whether the face area is detected.

8. The image processing method of claim 7, wherein the performing of the second color process is performed on the detected face area, when the face area is detected from the input image.

9. The image processing method of claim 8, further comprising:
extracting face information about the detected face area, wherein the performing of the second color process is performed on the face area based on the extracted face information.

10. The image processing method of claim 9, wherein, when at least two face areas are detected from the input image on which the first color process is performed, the extracting of the face information extracts face information about each of the detected at least two face areas, and the performing of the second color process performs different second color processes on the each of the detected at least two face areas according to each piece of face information.

11. The image processing method of claim 7, wherein the first and second color processes comprise at least one of a color reproduction matrix process, a hue control process, and a saturation control process.

12. A computer readable recording medium having recorded thereon a program for executing the method of claim 1.

13. An image processing apparatus comprising:
a face area detector which detects a face area from an input image; and
a color processor which performs a color process based on whether the face area is detected.

14. The image processing apparatus of claim 13, further comprising;
a controller which performs a first color process on the detected face area when the face area is detected from the input image, and performs a second color process on the input image when the face area is not detected from the input image.

15. The image processing apparatus of claim 14, further comprising:
a face information extractor which extracts face information about the detected face area, wherein the color processor performs the first color process on the face area based on the extracted face information.

16. The image processing apparatus of claim 15, wherein, when at least two face areas are detected from the input image, the controller extracts face information about each of the detected at least two face areas, and performs different first color processes on the each of the detected at least two face areas according to each piece of face information.

17. The image processing apparatus of claim 13, wherein the color processor comprises:
a color reproduction matrix which converts an RGB value of the input image;
a hue controller which emphasizes a hue component of the input image; and
a saturation controller which emphasizes a saturation component of the input image.

18. A digital photographing apparatus comprising the image processing apparatus of claim 13.

19. The digital photographing apparatus of claim 18, wherein the input image comprises a static image or a moving image.

20. The digital photographing apparatus of claim 19, wherein the input image comprises a live view image or a captured image.
